(19) United States
(12) Patent Application Publication
(10) Pub. No.: US 2005/0246657 A1
(43) Pub. Date: Nov. 3, 2005

(54) Video display arrangement including image processing circuitry for protecting display and method of protecting a video display

(76) Inventor: Steve W. Widner, Vermillion, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/837,946

(22) Filed: May 3, 2004

(51) Int. Cl. G06F 17/00

(52) U.S. Cl. 715/805; 715/867

(57) ABSTRACT

A video display arrangement includes a display, and a receiver. The receiver includes video imaging processing circuitry, the circuitry including a video formatter adapted to transmit formatted active image signals, a display buffer having a video display memory for temporarily storing the active image signals and transferring the active image signals to a display, a comparator for comparing one or more blocks of the video display memory for changing content over time and sending a static content warning signal to the video formatter when content in the one or more blocks remains static beyond a predetermined static content period, and program storage including one or more programs adapted to cause the video formatter to transfer a changing content image to the display buffer after receiving the static content warning signal.

### BACKGROUND AND SUMMARY

The present invention relates to video display arrangements and, more particularly, video display arrangements including screen saver technology.

There are presently a variety of television and computer monitor types of displays on the market. These displays include cathode ray tube devices, LCD devices, LED devices, VGA devices, and plasma displays. Often, these displays are used to display both active video images and static graphic images or content. For example, when Microsoft Corporation's MEDIA CENTER operating system is set up for automatic recording of, for example, television programming, a portion of a display is used to display active video images, while the remainder of the display is typically a static graphic image when the system resumes from standby or when a user chooses to watch a video image in a window while also using the computer for a second purpose such as browsing a web page, editing a file, etc.

In devices such as plasma displays, display of a static graphic image for an excessive period of time can result in an effect called “ghosting”, “screen burn”, or “burn in” that occurs when phosphors are energized to produce light and are continuously energized and, thus, are not provided any recovery time. As a result, the phosphors that are energized for too long “die”, usually more than about 15 minutes, and can result in an image being depicted on the screen that does not relate to the picture being shown. Typically, the burn in can be washed out over the course of several hours, but this is a significant inconvenience.

In other devices, even though they may not be susceptible to burn in, static display portions can be distracting or unattractive. In many devices, such as computer monitors, when static images are displayed on a display for an excessive period of time, a screen saver program will be activated.

Typically, activation of the screen saver program occurs as the result of the computer detecting of no movement of the computer keyboard, mouse, or other peripheral device. Many devices, such as televisions, however, do not have peripheral devices and are, of course, not well suited to be used with screen saver arrangements that depend upon the detection of movement of a peripheral device. Plasma television sets, for example, may not include control devices that would ordinarily be moved by a user every several minutes. Also, few devices do anything to change static content of composite images including both static and active images. In the present application, the term “composite” is used in the generic sense of referring to a signal composed of different parts as opposed to the industry established meaning relating to an A/V cable interface comprised of a yellow video cable, right red audio cable, and white left audio cable. In the present application, many possible interface options exist, such as composite, component, VGB, RGB, DVI, etc.

It is desirable to provide a display that can automatically apply a changing content image to portions of the display that display static content for an excessive period of time

In accordance with an aspect of the present invention, video imaging processing circuitry includes a video formatter adapted to transmit formatted active image signals, a display buffer having a video display memory for temporarily storing the active image signals and transferring the active image signals to a display, a comparator for comparing one or more blocks of the video display memory for changing content over time and sending a static content warning signal to the video formatter when content in the one or more blocks remains static beyond a predetermined static content period, and program storage including one or more programs adapted to cause the video formatter to transfer a changing content image to the display buffer after receiving the static content warning signal.

In accordance with another aspect of the present invention, a video display arrangement includes a display, and a receiver. The receiver includes video imaging processing circuitry, the circuitry including a video formatter adapted to transmit formatted active image signals, a display buffer having a video display memory for temporarily storing the active image signals and transferring the active image signals to a display, a comparator for comparing one or more blocks of the video display memory for changing content over time and sending a static content warning signal to the video formatter when content in the one or more blocks remains static beyond a predetermined static content period, and program storage including one or more programs adapted to cause the video formatter to transfer a changing content image to the display buffer after receiving the static content warning signal.

In accordance with yet another aspect of the present invention, a method for initiating a content changing program includes scanning a block of video display memory, comparing the scanned block of video display memory with a previously scanned block of video display memory, and initiating a content changing program if there is insufficient change of content between compared scanned blocks of video display memory.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic view of a video display arrangement according to an embodiment of the present invention;

FIG. 2 is a schematic view of a video display arrangement according to an embodiment of the present invention; and

FIG. 3 is a flow chart illustrating a method for initiating a changing content program according to an embodiment of the present invention.

### DETAILED DESCRIPTION

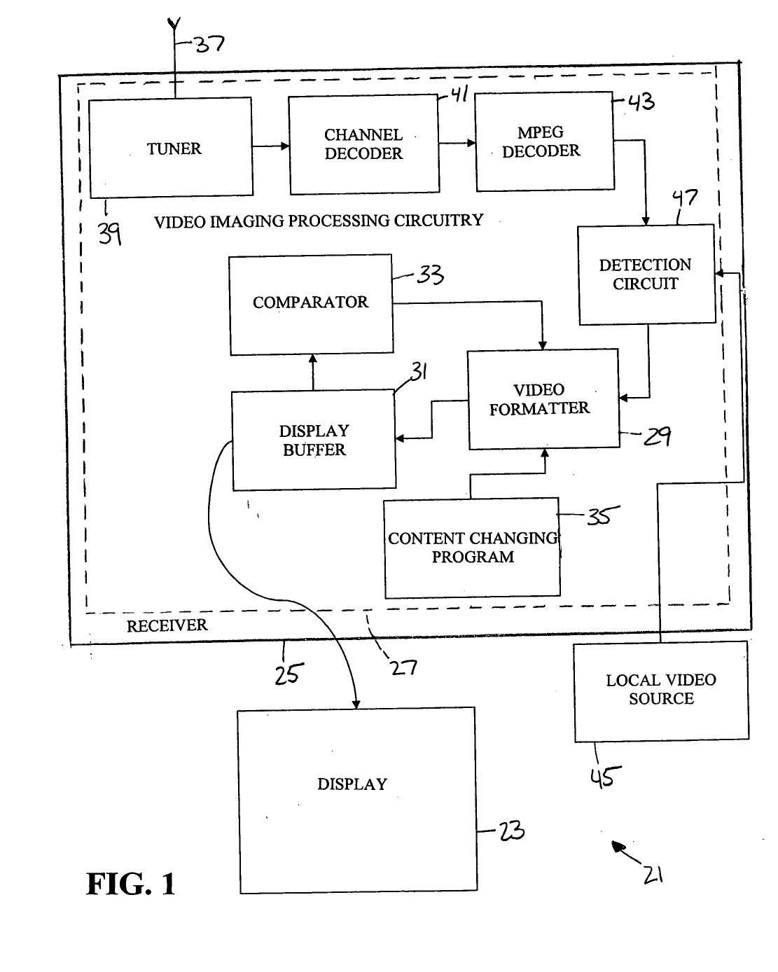

A video display arrangement 21 according to an embodiment of the present invention is seen in FIG. 1. The video display arrangement 21 includes a display 23 and a receiver 25. The display 23 may be any suitable form of display, such as a plasma display, and LCD display, CRT display such as a Super-VGA display, or an LED display. The display 23 may serve as a computer monitor, a television, or other video device. The present invention is, however, considered to have particular applicability to displays susceptible to problems with “burn-in”, such as plasma displays.

In the embodiment shown in FIG. 1, the receiver 25 includes video imaging processing circuitry 27. The circuitry 27 includes a video formatter 29 adapted to transmit formatted image signals, a display buffer 31 having a video display memory for temporarily storing the image signals and transferring the image signals to a display, and a comparator 33 for comparing one or more blocks of the video display memory for changing content over time and sending a static content warning signal to the video formatter when content in the one or more blocks remains static beyond a predetermined static content period. “Blocks” of video display memory can correspond to as little as a single pixel on the display 23, if desired.

The circuitry 27 also includes a suitable form of program storage 35 including one or more programs adapted to cause the video formatter to transfer a changing content image to the display buffer after receiving the static content warning signal. The video formatter 29 is adapted to transfer a changing content image such as a screen saver video image to the display buffer 31 after receiving the static content warning signal.

The program storage 35 may be in the form of, for example, a screen saver library 35 including one or more screen savers. In addition to or instead of a screen saver, the display 23 may be blanked by, for example, using I/O control signals or general purpose control lines connected to a CPU, graphics chip, video memory, or other portion of the video display arrangement 21. Static areas of the display 23 may also be protected by writing a value to a control register or through the use of memory mapped I/O. The program storage 35 may also be adapted to provide for non-traditional screen saving technology, such as computing a different color or hue that approximates the original content while limiting damage, and/or allowing a range of colors or hues to be cycled through. For discussion purposes, and not by way of limitation, the present invention is described in connection with the application of a conventional screen saver, except where otherwise noted.

The video display arrangement 21 will ordinarily also include other conventional features, such as an antenna 37 coupled to the receiver 25. The receiver 25 can include conventional features such as a tuner 39, a channel decoder 41, and an MPEG (Moving Pictures Expert Group) decoder 43. The tuner 39 deconverts a user-selected broadcast television signal to produce an intermediate frequency (IF) signal. The channel decoder 41 demodulates the IF signal to produce MPEG data streams that are input to the MPEG decoder 43. The MPEG decoder 43 decompresses the MPEG signals according to one of several MPEG standards to produce a baseband video signal. The video imaging processing circuitry 27 further processes the output from the MPEG decoder 43 to produce enhanced video images for transfer to the display 23.

Instead of or in addition to receiving broadcast signals, the receiver 25 may receive signals from a local video source 45 such as a video cassette recorder (VCR), a compact disk/digital versatile disk (CD/DVD) player, a computer, or some other source of video images. The local video source 45 is ordinarily connected directly to the video imaging processing circuitry 27.

It will be desirable for the video formatter 29 to be adapted to transfer a warning signal to the display buffer 31 after receiving a static content warning signal and prior to transferring the screen saver video image. The warning signal can be displayed on the display 23 as a message warning an operator that, for instance, screen burn-in damage may occur if the image displayed remains static for too long and recommend that a screen saver be activated. An operator can send a response signal in response to the warning signal to prevent the video formatter 29 from transferring the screen saver video image. The response signal can be sent using any number of suitable devices, such as user interface devices such as a keyboard, a mouse, a touchpad, a joystick, a television remote control, a voice-activated switch, or a button or switch on, for instance, the display 23 or receiver 25. The response signal may be sent through a hard-wired connection or wirelessly as desired. The video formatter 29 can be adapted to automatically transfer the screen saver video image to the display buffer 31 if the response signal is not received in the predetermined response period.

The video imaging processing circuitry 27 will ordinarily be adapted to send composite video signals including both static graphics signals and what shall be referred to as active video signals. For example, when using the Microsoft XP MEDIA CENTER software, the display 23 may include a windowed active video portion 23v surrounded by a static graphics portion 23g when the system resumes from standby or when a user chooses to watch a video image in a window while also using the computer for a second purpose such as browsing a web page, editing a file, etc. The comparator 33 may be adapted to identify those portions of the display that are static and those that include moving images and send that information to the video formatter 29. The video formatter 29 may then apply a screen saver to those portions of the display 23 that are static, such as a graphics portion 23g, while leaving the active video portion 23v unaffected.

There are a variety of ways that static portions of the display 23 can be identified. For example, the comparator 33 may be adapted to scan the video memory corresponding to the entire display 23, identify static portions, and transmit data corresponding to the static portions to the video formatter 29 so that the video formatter can apply a screen saver to the static portions.

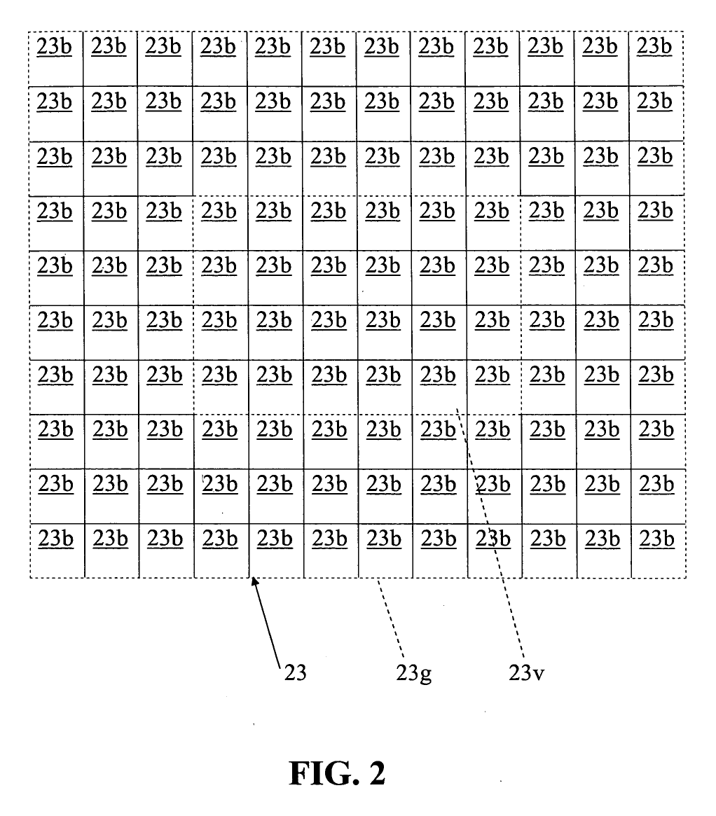

Another way to identify static portions of the display 23 is for the comparator 33 to divide the video display memory into a plurality blocks corresponding to blocks 23b of the display 23, as seen in FIG. 2. These blocks 23b, which hereinafter are understood to refer to blocks of the video display memory, except where otherwise noted, can be compared for changing content over time. After one block 23b is compared, the comparator 33 moves on to the next block. For each block that is compared, if it is determined that the content of the block has been static for too long a period of time, the video formatter 29 can apply a screen saver to the block. Again, these “blocks” of video display memory can correspond to as little as a single pixel on the display 23, if desired.

A detection circuit 47 for receiving a video signal from a video source and transferring the video signal to the video formatter 29 may be provided. The detection circuit 47 may be adapted to detect an incoming video signal and information about the video signal, such as an aspect ratio of a video image portion of the signal, and compare the aspect ratio of the video image to a known aspect ratio of the display 23, determine if the aspect ratios are different and, if so, send a signal to the video formatter 29 to apply a changing content image to any blank portions of the display.

It will, additionally, be understood that references to “static” content includes content in a block that changes at less than a predetermined level of change. “Static” does not mean that there cannot be some change in a block. Ordinarily, in plasma displays, the level of change below which a screen saver will be applied to the screen is one where, if the level of change of content in the block is not increased, the portion of the display corresponding to the block will suffer burn-in damage.

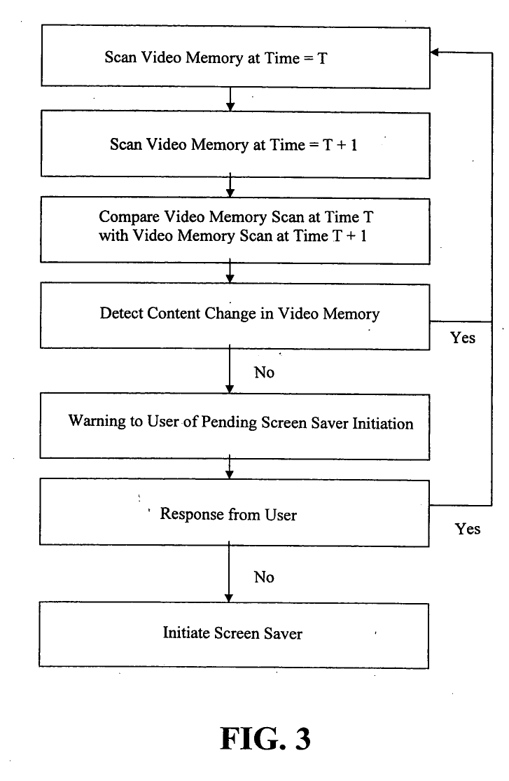

In a method for initiating a content changing program for a display described in connection with the flow diagram of FIG. 3, a block of video display memory, i.e., a portion of the memory corresponding to a portion to the display, is scanned. The scanned block of video display memory is compared with a previously scanned block of video display memory. A content changing program is initiated if there is insufficient change of content between compared scanned blocks of video display memory. Ordinarily, the scanning and comparing steps are repeated at predetermined intervals and the content changing program is initiated if there is no change of content between compared scanned blocks of video display memory beyond a predetermined static content period.

A warning message may be generated before initiating the content changing program. The content changing program may be initiated if no user-generated signal in response to the warning message is received in a predetermined response period.

The method may also include identifying whether the video display memory includes both static content portions and dynamic content portions and, if there are both static content portions and dynamic content portions, initiating the content changing program for the static content portions. The content changing program may be a screen saver or other suitable program.

If desired, the circuitry 27 can be arranged to initiate or discontinue the content changing program at a user's command. Similarly, a display 23 provided with video imaging processing circuitry according to the present invention can have the content changing program turned off so that, even if a static image is displayed for any length of time, the content changing program will not initiate.

While this invention has been illustrated and described in accordance with a preferred embodiment, it is recognized that variations and changes may be made therein without departing from the invention as set forth in the claims.

1. Video imaging processing circuitry, comprising:
a video formatter adapted to transmit formatted active image signals;
a display buffer having a video display memory for temporarily storing the active image signals and transferring the active image signals to a display;
a comparator for comparing one or more blocks of the video display memory for changing content over time and sending a static content warning signal to the video formatter when content in the one or more blocks remains static beyond a predetermined static content period; and
program storage including one or more programs adapted to cause the video formatter to transfer a changing content image to the display buffer after receiving the static content warning signal.

2. The video imaging processing circuitry as set forth in claim 1, wherein the one or more programs includes a screen saver library including one or more screen savers, the video formatter being adapted to transfer a screen saver video image to the display buffer after receiving the static content warning signal.

3. The video imaging processing circuitry as set forth in claim 1, wherein the video formatter is adapted to transfer a warning signal to the display buffer after receiving the static content warning signal and prior to transferring the screen saver video image.

4. The video imaging processing circuitry as set forth in claim 3, further comprising means for sending a response signal in response to the warning signal to prevent the video formatter from transferring the screen saver video image.

5. The video imaging processing circuitry as set forth in claim 4, wherein the video formatter is adapted to transfer the screen saver video image to the display buffer if the response signal is not received in a predetermined response period.

6. The video imaging processing circuitry as set forth in claim 3, wherein the video formatter is adapted to transfer the screen saver video image to the display buffer if the response signal is not received in a predetermined response period.

7. The video imaging processing circuitry as set forth in claim 1, further comprising a detection circuit for receiving a video signal from a video source and transferring the video signal to the video formatter.

8. The video imaging processing circuitry as set forth in claim 1, wherein the one or more blocks is a portion of the video display memory.

9. The video imaging processing circuitry as set forth in claim 1, wherein the one or more blocks is the entire video display memory.

10. The video imaging processing circuitry as set forth in claim 1, wherein the one or more blocks corresponds to one or more pixels on a video display.

11. The video imaging processing circuitry as set forth in claim 1, wherein static content includes content changes less than a predetermined level of change.

12. A video display arrangement, comprising:
a display;
a receiver, the receiver including video imaging processing circuitry, the circuitry including a video formatter adapted to transmit formatted active image signals, a display buffer having a video display memory for temporarily storing the active image signals and transferring the active image signals to a display, a comparator for comparing one or more blocks of the video display memory for changing content over time and sending a static content warning signal to the video formatter when content in the one or more blocks remains static beyond a predetermined static content period, and program storage including one or more programs adapted to cause the video formatter to transfer a changing content image to the display buffer after receiving the static content warning signal.

13. The video display arrangement as set forth in claim 12, wherein the display is a plasma display.

14. The video display arrangement as set forth in claim 12, wherein the video formatter is adapted to transfer a warning signal to the display buffer after receiving the static content warning signal and prior to transferring the changing content image.

15. The video display arrangement as set forth in claim 14, further comprising means for sending a response signal in response to the warning signal to prevent the video formatter from transferring the changing content image.

16. The video display arrangement as set forth in claim 15, wherein the video formatter is adapted to transfer the changing content image to the display buffer if the response signal is not received in a predetermined response period.

17. The video display arrangement as set forth in claim 16, wherein the sending means includes a user interface.

18. The video display arrangement as set forth in claim 16, wherein the user interface includes a keyboard.

19. The video display arrangement as set forth in claim 16, wherein the user interface includes a mouse.

20. The video display arrangement as set forth in claim 16, wherein the user interface includes a remote control device.

21. The video display arrangement as set forth in claim 16, wherein the user interface sends the response signal wirelessly.

22. The video display arrangement as set forth in claim 16, wherein the user interface is voice activated to send the response signal.

23. The video display arrangement as set forth in claim 12, wherein the display includes one or more pixels.

24. The video display arrangement as set forth in claim 12, wherein static content includes content changes less than a predetermined level of change.

25. The video display arrangement as set forth in claim 12, wherein the one or more programs includes a screen saver library including one or more screen savers, the video formatter being adapted to transfer a screen saver video image to the display buffer after receiving the static content warning signal.

26. The video display arrangement as set forth in claim 12, wherein the display is a display susceptible to screen burn in damage.

27. A method for initiating a content changing program, comprising:
scanning a block of video display memory;
comparing the scanned block of video display memory with a previously scanned block of video display memory;
initiating a content changing program if there is insufficient change of content between compared scanned blocks of video display memory.

28. The method as set forth in claim 27, wherein the scanning and comparing steps are repeated at predetermined intervals and the content changing program is initiated if there is no change of content between compared scanned blocks of video display memory beyond a predetermined static content period.

29. The method as set forth in claim 28, comprising generating a warning message before initiating the content changing program.

30. The method as set forth in claim 29, comprising initiating the content changing program if no user-generated signal in response to the warning message is received in a predetermined response period.

31. The method as set forth in claim 27, comprising identifying whether the video display memory includes both static content portions and dynamic content portions and, if there are both static content portions and dynamic content portions, initiating the content changing program for the static content portions.

32. The method as set forth in claim 27, wherein the content changing program includes a screen saver program.
